(19) United States
(12) Patent Application Publication
(10) Pub. No.: US 2004/0165376 A1
(43) Pub. Date: Aug. 26, 2004

(54) Decoration fixture of ceiling lamp

(76) Inventor: Wen-Chang Wu, Chang Hua Hsien (TW)

Correspondence Address: Troxell Law Office PLLC, ONE SKYLINE PLACE, 5205 LEESBURG PIKE, SUITE 1404, FALLS CHURCH, VA, 22041, US

(21) Appl. No.: 10/369,653

(22) Filed: Feb. 21, 2003

(51) Int. Cl. F21S 8/00

(52) U.S. Cl. 362/147

(57) ABSTRACT

The present invention discloses an improved decoration fixture of a ceiling lamp, which can fix a decoration around the external periphery of a lamp rod of a ceiling lamp, comprising a restricting bar installed on the lamp rod in advance, and a decoration tied to the restricting bar; wherein the restricting bar attaches onto the external periphery of the lamp rod along the curvature of the lamp rod, and has a protruded latch disposed at every interval of appropriate length such that the protruded latch can appropriately fix the decoration into a position. A tying string passes through the protruded latch of the restricting bar and ties a decoration on the string to position the decoration on the external periphery of the lamp rod. Since after the string tying the decoration passes through the protruded latch of the restricting bar, the string is tied directly on the protruded latch of the restricting bar such that the string will not tangle with the lamp rod, or affect the external look of the overall lamp rod.

### BACKGROUND OF THE INVENTION

1. Field of the Invention

The present invention relates to a decoration fixture of ceiling lamp, more particularly to an improved decoration fixture of ceiling lamp that fixes the decoration onto the ceiling lamp without affecting the external look of the overall lamp rod.

2. Description of the Related Art

Please refer to FIG. 1A and 1B for a prior-art decoration fixture of a ceiling lamp, which attaches a decoration 3 onto a lamp rod 1 according to the curvature of the lamp rod 1, and after a string 4 ties the decoration 3 onto the periphery of the lamp rod 1, the decoration 3 is fixed onto the lamp rod 1 to accomplish the purpose of decorating the lamp rod 1.

However, after the string 4 passes through the wire 31 of the decoration 3, the decoration 3 is tied onto the body of the lamp rod 1 directly, and such string will be exposed and seen around the periphery of the lamp rod 1 which affects the artistic look of the lamp rod 1. In view of the above shortcomings, the inventor studied and researched this subject and finally invented the present invention.

### SUMMARY OF THE INVENTION

The primary objective of this invention is to provide an improved decorative fixture of a ceiling lamps, which can fix a decoration around the external periphery of a lamp rod of a ceiling lamp, comprising a restricting bar installed on a lamp rod in advance, and a decoration tied to the restricting bar; wherein the restricting bar attaches onto the external periphery of the lamp rod according to the curvature of the lamp rod, and has a protruded latch disposed at every interval of appropriate length such that the protruded latch can appropriately fix the decoration into a position. A tying string passes through the protruded latch of the restricting bar and ties a decoration on the string to position the decoration on the external periphery of the lamp rod. Since after the string tying the decoration passes through the protruded latch of the restricting bar, the string is tied directly on the protruded latch of the restricting bar such that the string will not tangle to the lamp rod, or affect the external look of the overall lamp rod.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1A is a diagram illustrating the actions of tying a decoration to a lamp rod according to the prior art.

FIG. 1B is a diagram of the external look of the decoration being tied to a lamp rod according to the prior art.

FIG. 2 is a diagram of the disassembled parts of the present invention.

FIG. 3 is a diagram of the external look of the decoration being tied to a lamp rod according to the present invention.

FIG. 4 is a diagram of the external look of the lamp rod according to the present invention.

FIG. 5 is a diagram of another embodiment of the present invention.

FIG. 5A is a diagram showing the double-sided clipping situation of the fixing clip of the present invention.

### DETAILED DESCRIPTION OF THE PREFERRED EMBODIMENTS

In the detailed description of the preferred embodiments, it should be noted that like elements are indicated by the same reference numerals throughout the disclosure.

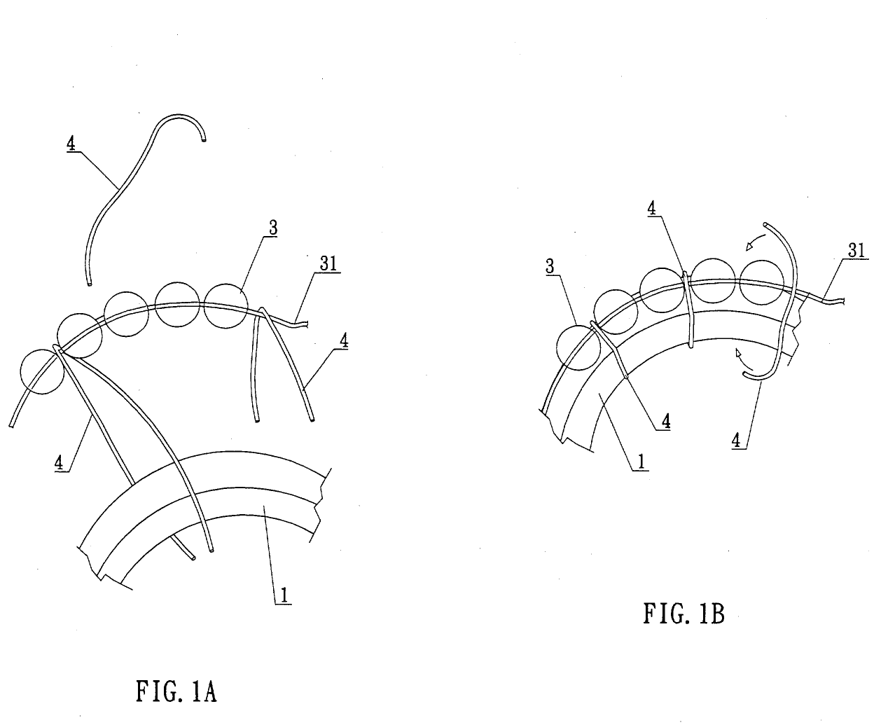

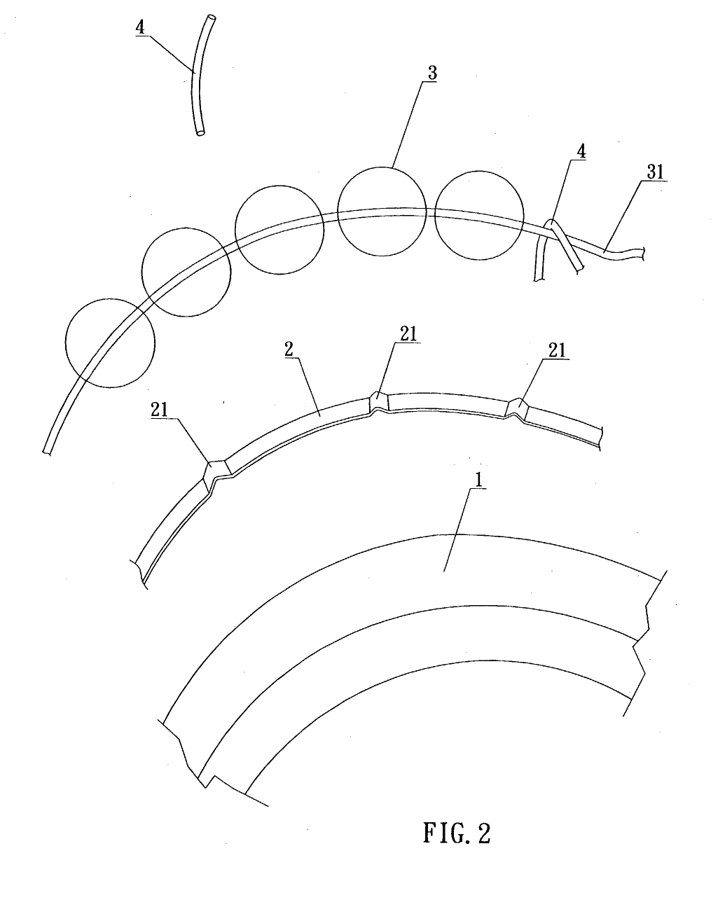

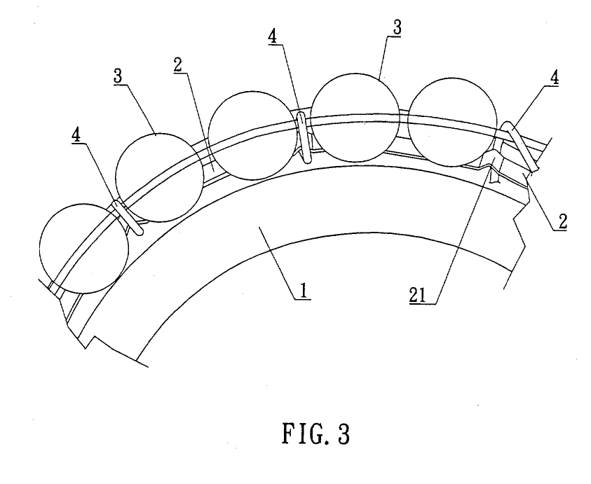

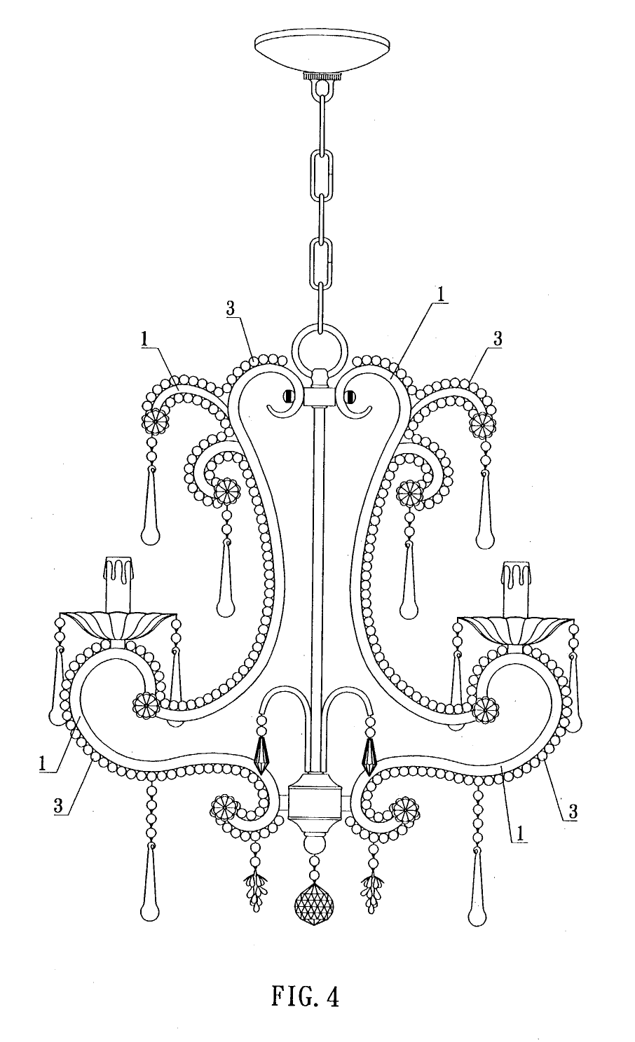

Refer to FIGS. 1 and 2 for the structure of the present invention. The present invention is a utility model capable of fixing a decoration onto the periphery of a lamp rod by installing a restricting bar 2 on a lamp rod 1 in advance, and then tying a decoration 3 onto the restricting bar 2; wherein said restricting bar 2 attaches onto the external periphery of the lamp rod 1 along the curvature of the lamp rod 1, and has a protruded latch 21 disposed at every interval of appropriate length of the restricting bar 2 such that the protruded latch 21 can appropriately fix the decoration 3 into a position. A tying string 4 passes through the protruded latch 21 of the restricting bar 2 and ties a decoration 3 on the wire 31 to position the decoration 3 on the external periphery of the lamp rod 1 to accomplish the purpose of decorating the lamp rod 1.

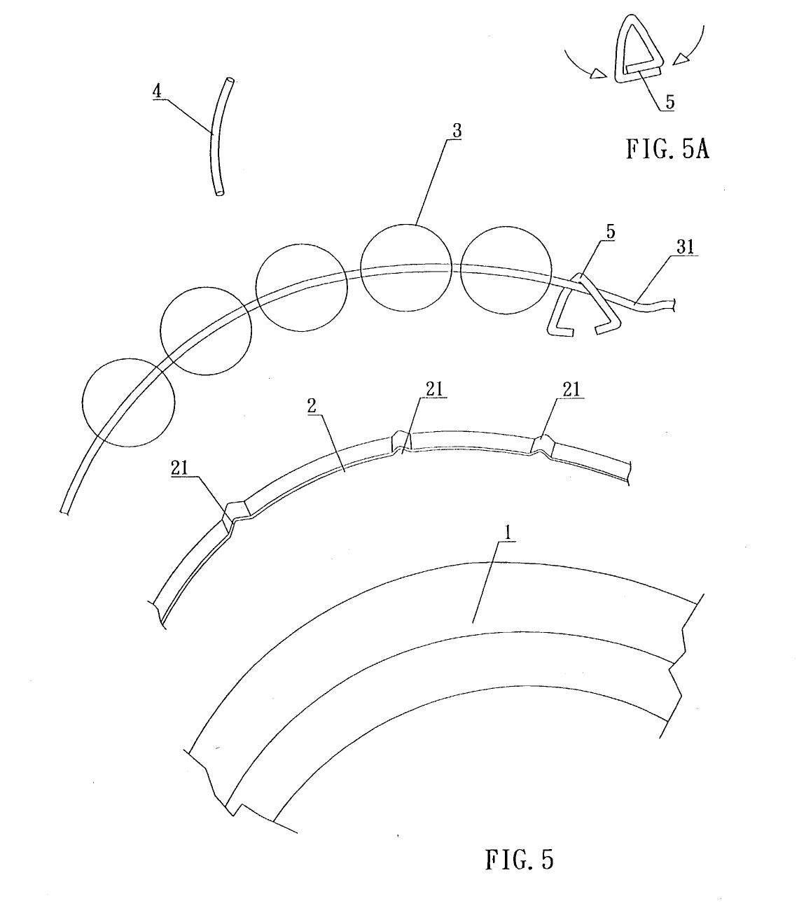

Refer to FIGS. 5 and 5A. A fixing clip 5 passes through the wire 31 of the decoration 3 and the protruded latch 21 of the restricting bar 2 and clips them together with the from force from both sides inward so that the ends of the fixing clip 5 are engaged to clip the decoration 3 and the restricting bar 2 in a fixed position.

Since after the string tying the decoration passes through the protruded latch of the restricting bar, the string is tied directly on the protruded latch of the restricting bar and will not tangle to the lamp rod, or affect the external look of the overall lamp rod.

In summation of the above description, the structure of the improved decoration fixture of ceiling lamp disclosed by the present invention is novel, and definitely can accomplish the function as described above, herein complies with the patent application requirements, and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved decoration fixture of ceiling lamp, installing a restricting bar onto a lamp rod in advance, and then tying a decoration onto the restricting bar; wherein:
said restricting bar attaching onto the external periphery of said lamp rod along the curvature of said lamp rod, and having a protruded latch disposed at every interval of appropriate length such that said protruded latch appropriately fixing the decoration into a position; a tying string passing through said protruded latch of said restricting bar and tying the decoration on said string to position the decoration oil the external periphery of said lamp rod; since after the string tying the decoration passing through the protruded latch of the restricting bar, the string being tied directly on the protruded latch of the restricting bar such that the string not tangling with the lamp rod, or affecting the overall external look of said lamp rod.

2. An improved decoration fixture of ceiling lamp as claimed in claim 1, wherein said protruded latch of the restricting bar and said wire of the decoration pass through a clip, and said clip is clipped inward from both sides such that both ends of the clip are engaged.
